(19) United States
(12) Patent Application Publication
(10) Pub. No.: US 2019/0219333 A1
(43) Pub. Date: Jul. 18, 2019

(54) FURNACE SIDEWALL WITH SLAG RETAINERS

(71) Applicant: Systems Spray-Cooled, Inc, Smyrna, TN (US)

(72) Inventors: Scott A. FERGUSON, Murfreesboro, TN (US); Troy D. WARD, Franklin, TN (US); Logan WILSON, Smyrna, TN (US); Eric CHODL, Smyrna, TN (US)

(21) Appl. No.: 15/874,349

(22) Filed: Jan. 18, 2018

(51) Int. Cl. F27D 1/00; C21B 7/10; F27B 3/24; F27B 3/10

(52) U.S. Cl. CPC F27D 1/0003; F27B 3/105; F27B 3/24; C21B 7/10

(57) ABSTRACT

A furnace sidewall having slag retainers and metallurgical furnace having the same metallurgical furnace are disclosed herein. In one example, a furnace sidewall is provided that includes a hot plate and a plurality of slag retainers. The hot plate has an inner surface facing configured to face an interior volume of a metallurgical furnace and a bottom surface configured to face a hearth of the metallurgical furnace. The plurality of slag retainers extend inwardly from the inner surface of the hot plate and are arranged in a macro-pattern of slag retainer groups. The slag retainer groups include at least two or more of the slag retainers arranged in a micro-pattern.

### BACKGROUND OF THE DISCLOSURE

### Field of the Disclosure

Embodiments of the present disclosure relates generally to a sidewall for a metallurgical furnace, and more particularly to a furnace sidewall having slag retainers and metallurgical furnaces having the same.

### Description of the Related Art

Metallurgical furnaces (e.g., an electric arc furnace or a ladle metallurgical furnace) are used in the processing of molten metal materials. The electric arc furnace heats charged metal in the furnace by means of an electric arc from a graphite electrode. The electric current from the electrode passes through the charged metal material forming a molten bath of the metal materials. The furnaces house the molten materials during the processing of the molten materials forming molten steel and slag (a stony waste material).

A metallurgical furnace as above described is typically made of steel, aluminum, aluminum base alloys, copper, copper base alloys and metals having similar thermal characteristics and have metal slag retainers, made from the aforesaid metals attached to the furnace side of the metal closure elements. These slag retainers, typically cup-shaped to aid in slag retention and being unprotected from the high furnace temperatures, have a relatively short life due to overheating and oxidation. The use of the more oxidation resistant and thermally conductive materials in the slag retainers would result in substantially higher cost without commensurate benefit. The furnace must be shut down to replace or install new slag retainers, which is often down with refurbishing the sidewall of the furnace. Thus, replacing slag retainers is a costly endeavor.

Therefore, there is a need for an improved a furnace sidewall having slag retainers and metallurgical furnaces having the same.

### SUMMARY

A furnace sidewall having slag retainers and metallurgical furnaces having the same are disclosed herein. In one example, a furnace sidewall is provided that includes a hot plate and a plurality of slag retainers. The hot plate has an inner surface facing configured to face an interior volume of a metallurgical furnace and a bottom surface configured to face a hearth of the metallurgical furnace. The plurality of slag retainers extend inwardly from the inner surface of the hot plate and are arranged in a macro-pattern of slag retainer groups. The slag retainer groups include at least two or more of the slag retainers arranged in a micro-pattern.

In another example, furnace sidewall is provided that includes a ring-shaped steel hot plate and a plurality of slag retainers. The hot plate has an inner surface facing inward. The plurality of slag retainers are welded to the inner surface of the hot plate. The slag retainers project inward from the inner surface and are arranged in a pattern of discrete slag retainer groups. The retainer groups have a substantially similar micro-pattern and are comprised of at least two spaced apart slag retainers of the plurality of slag retainers. The two spaced apart slag retainers have different geometric orientations.

In yet another embodiment, a metallurgical furnace is provided. The metallurgical furnace includes a sidewall disposed on a hearth. The sidewall surrounds an interior volume of the metallurgical furnace. The sidewall includes a hot plate having an inner surface facing the interior volume, a cover plate surrounding the hot plate in a spaced-apart relation, a plurality of spray nozzles disposed in a volume defined between the cover plate and hot plate, and a plurality of slag retainers welded to the inner surface of the hot plate. The spray nozzles are oriented to spray a liquid on the hot plate. The slag retainers project inward from the inner surface of the hot plate and are arranged in a pattern of discrete slag retainer groups. The retainer groups have a substantially similar micro-pattern comprised of at least two spaced apart slag retainers of the plurality of slag retainers. The two spaced apart slag retainers have different geometric orientations.

### BRIEF DESCRIPTION OF THE DRAWINGS

So that the way the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an elevational side view of a metallurgical furnace.

FIG. 2 illustrates a partial horizontal sectional view the sidewall of the metallurgical furnace of FIG. 1.

FIGS. 3-10 are schematic elevation views of various patterns of slag retainers, which may be utilized on the sidewall illustrated in FIG. 2.

FIGS. 11A-11D are schematic partial cross-sectional views depicting a method for fixing the metallic structures to the inner surface of the hot plate to form the micro-patterns and the macro-patterns described in FIGS. 3-5.

To facilitate understanding, identical reference numerals have been used, where possible, to designate identical elements that are common to the figures. It is contemplated that elements disclosed in one embodiment may be beneficially utilized with other embodiments without specific recitation.

### DETAILED DESCRIPTION

The present invention is directed to a furnace sidewall having slag retainers and metallurgical furnaces having the same. The sidewall of the metallurgical furnace includes a spray-cooled hot plate that faces the interior of the furnace. Slag retainers are disposed on the hot plate. The slag retainers enhance the ability of the hot plate to hold and retain slag on the surface of the sidewall facing the interior of the furnace. The retained slag functions to insulate and protect the hot plate, thereby extending the service life of the hot plate. Groups of slag retainers are arranged in a macro-pattern across the surface of the hot plate. The slag retainers comprising each group are arranged in a micro-pattern that includes at least two slag retainers. The micro-pattern is repetitive across the macro-pattern. While not detailed herein, a macro slag retainer pattern comprising micro-patterns of slag retainers may also be provided on an inner surface of a hot plate of other spray-cooled components utilized in the furnace, such as a spray-cool roof that is disposed on the sidewall.

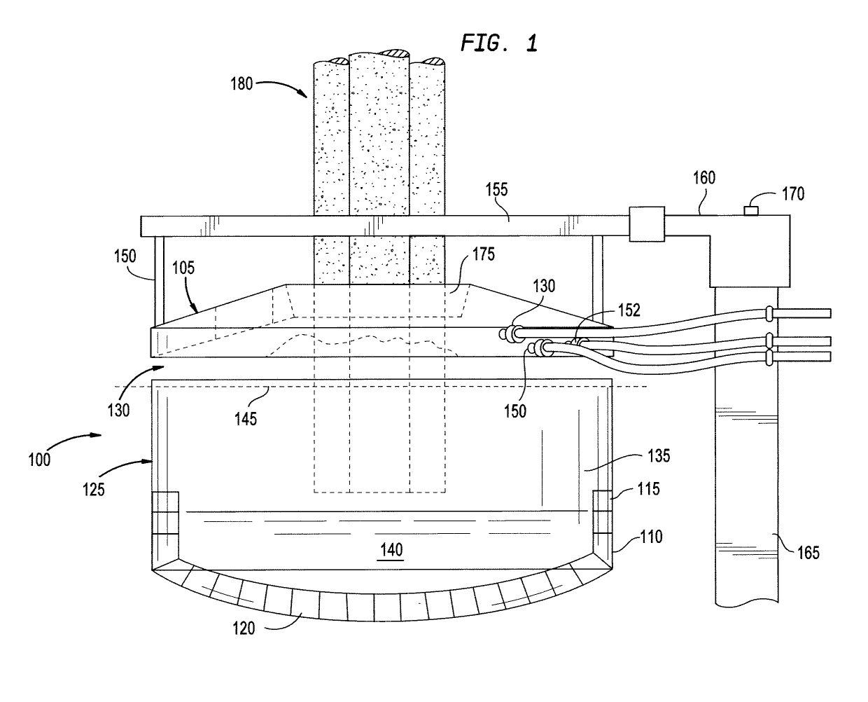

FIG. 1 illustrates an elevational side view of a metallurgical furnace 100 having a spray-cooled roof 105 removably disposed on a furnace body 110. The body 110 includes a spray-cooled sidewall 125 disposed on a hearth 115. The hearth 115 is lined with refractory brick 120. The sidewall 125 has a top 130. The spray-cooled roof 105 is moveably disposed on the top 130 of the sidewall 125. The spray-cooled roof 100 and furnace body 110 enclose an interior volume 135 of the metallurgical furnace 100. The interior volume 135 may be loaded or charged with material 140, e.g., metal, scrap metal, or other meltable material, which is to be melted within the metallurgical furnace 100.

The metallurgical furnace 100, including the body 110 and the spray-cooled roof 105, is rotatable along a tilt axis 145. The metallurgical furnace 100 may be tilted in a first direction about the tilt axis 145 toward the slag door (not shown) multiple times during a single batch melting process, sometimes referred to as a “heat”, to remove slag. Similarly, the metallurgical furnace 100 may be tilted in a second direction about the tilt axis 145 towards a tap spout (not shown) multiple times during a single batch melting process including one final time to remove the molten material 140.

Roof lift members 150 may be attached at a first end to the spray-cooled roof 105. The roof lift members 150 may be chains, cables, ridged supports, or other suitable mechanisms for supporting the spray-cooled roof 105. The roof lift members 150 may be attached at a second end to one or more mast arms 155. The mast arms 155 extend horizontally and spread outward from a mast support 160. The mast support 160 may be supported by a mast post 165. A coupling 170 may attach the mast post 165 to the mast support 160. The mast support 160 may rotate about the coupling 170 and the mast post 165. Alternately, the mast post 165 may rotate with the mast support 160 for moving the roof lift members 150. In yet other examples, roof lift members 150 may be aerially supported to move the spray-cooled roof 105. In one embodiment, the spray-cooled roof 105 is configured to swing or lift away from the sidewall 125. The spray-cooled roof 105 is lifted away from the sidewall 125 to expose the interior volume 135 of the metallurgical furnace 100 through the top 130 of the sidewall 125 for loading material therein.

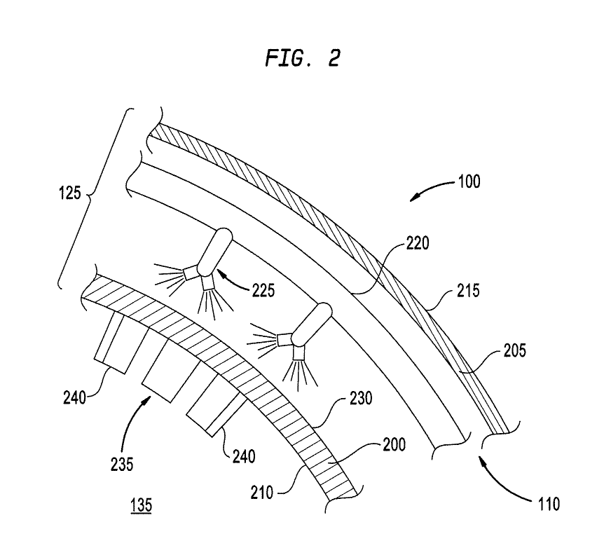

At least the sidewall 125 of the body 110 may be ring, oval or circular-shaped when viewed from a top plan view, of which a portion is shown in FIG. 2. Likewise, the spray-cooled roof 105 a shape complimentary to that of the sidewall 125 so that the interior volume 135 may be enclosed.

A central opening 175 may be formed through the spray-cooled roof 105. Electrodes 180 extend through the central opening 175 from a position above the spray-cooled roof 105 into the interior volume 135. During operation of the metallurgical furnace 100, the electrodes 180 are lowered through the central opening 175 into the interior volume 135 of the metallurgical furnace 100 to provide electric arc-generated heat to melt the material 140.

The spray-cooled roof 105 may further include an exhaust port to permit removal of fumes generated within the interior volume 135 of the metallurgical furnace 100 during operation.

FIG. 2 illustrates a partial horizontal sectional view of the sidewall 125 of the metallurgical furnace 100 of FIG. 1. The sidewall 125 comprises a hot plate 200 and a cover plate 205, both of which are shown in cross-section in FIG. 2. The hot plate 200 is coupled in a spaced apart relation to the cover plate 205. Like the sidewall 125, the hot plate 200 and the cover plate 205 have a ring, oval or circular-shape, a section of which is shown in FIG. 2. The hot plate 200 is fabricated from steel or other suitable material. An inner surface 210 of the hot plate 200 faces the interior volume 135 of the metallurgical furnace 100 (shown in FIG. 1) and an outer surface 215 of the cover plate 205 faces ambient environment where the metallurgical furnace 100 is utilized.

A manifold 220 is provided in the volume between the cover plate 205 and the hot plate 200. A plurality of nozzles 225 are coupled to the manifold 220. Liquid, such as water, is provided through the manifold 220 to the nozzles 225 such that the liquid may be sprayed through the nozzles 225 onto an outer surface 230 of the hot plate 200. The liquid is utilized to cool the hot plate 200 during operation of the metallurgical furnace 100 to prevent damage to the sidewall 125.

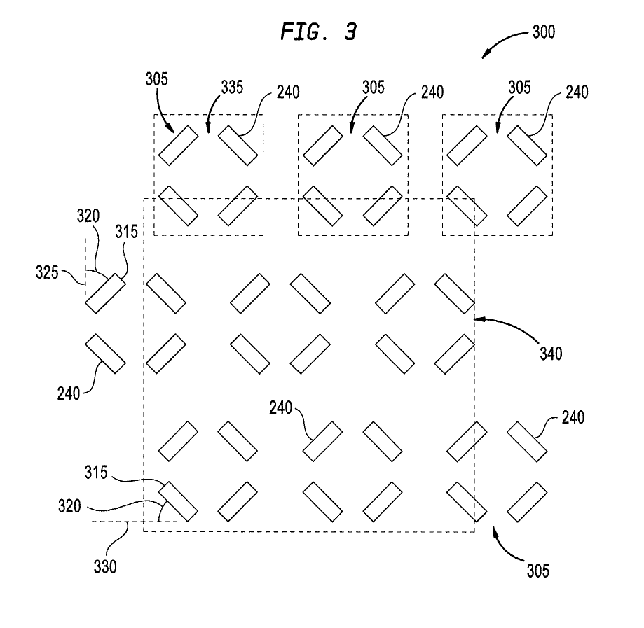

A plurality of slag retainers 240 are coupled to the inner surface 210 of the hot plate 200. The plurality of slag retainers 240 are arranged in a pattern 235. The pattern 235 generally includes a repetitive micro-pattern, where the micro-pattern includes at least two slag retainers 240 of the plurality of slag retainers 240 that have different geometric orientations, as further discussed below with reference to FIGS. 3-5. However, the pattern 235 may alternatively comprise a repetitive pattern of capacitively discharge welded high aspect ratio slag retainers 240. A high aspect ratio slag retainers 240 is one that has a height at least 2, for example 3 to 4, times the mean width of the surface of the slag retainer 240 that is welded to the hot plate 200. The slag retainers 240 project from the inner surface 210 of the hot plate 200 into the interior volume 135 of the metallurgical furnace 100. The pattern 235 of the slag retainers 240 is configured to trap slag produced by a batch melting process in the metallurgical furnace 100 so that the slag retained to the hot plate 200 by the slag retainers 240 functions to insulate the hot plate 200 from the heat generated in the interior volume 135 of the metallurgical furnace 100 during operation of the furnace 100.

While the pattern 235 of slag retainers 240 are described in FIG. 2 as being provided on the inner surface 210 of the hot plate 200, the pattern 235 of slag retainers 240 may also be provided on an inner surface of a hot plate of the spray-cooled roof 105 of FIG. 1.

FIGS. 3-10 are schematic elevation views of various patterns of slag retainers, which may be utilized as the pattern 235 of FIG. 2. The patterns of at least FIGS. 3-5 generally include a macro-pattern made up of groups of slag retainers having a repetitive micro-pattern. It is contemplated that other patterns may be utilized.

FIG. 3 shows a macro-pattern 300 of slag retainer groups 305. Each slag retainer groups 305 includes at least two slag retainers 240. Some of the groups 305 illustrated in FIG. 3 are bounded by a dashed line to better illustrate the discrete repetitive nature of the groups 305 within the overall pattern of the macro-pattern 300. The slag retainers 240 comprising each group 305 are arranged in micro-pattern. Each group 305 of slag retainers 240 comprising the macro-pattern 300 include at least two slag retainers 240 having different geometric orientations. Adjacent groups 305 of slag retainers 240 of the macro-pattern 300 may have slag retainers 240 arranged in a substantially same micro-pattern that repeat over the inner surface 210 of the hot plate 200. Alternatively, the micro-pattern of one group 305 may include slag retainers 240 arranged in a geometric pattern that is different than a micro-pattern of another group 305 of slag retainers 240 comprising the macro pattern 300. In yet another example, the micro-pattern of one group 305 may include more slag retainers 240 than a micro-pattern of another group 305 of slag retainers 240 comprising the macro pattern 300.

In one example, each slag retainer 240 is a steel stud. The steel stud has a rectangular cross-section and a height (the height extending out of the page). In another example, the steel stud may have a circular, oval or other cross-sectional profile. In one example the steel stud has a high aspect ratio in that the height of the stud is at least 2 times, such as 3 to 4, greater than the average width of the rectangular cross-section.

Generally, the space between each of the slag retainers 240 comprising a common group 305 is less than a space between neighboring groups 305 such that the discrete identification of the individual groups 305 is readily apparent. However, the spacing between slag retainers 240 comprising a common group 305 may be substantially equal to the space between neighboring groups 305.

The slag retainers 240 comprising an individual group 305 may be arranged in a wave, spiral, curve, linear, off-set, polygonal, quadrilateral, triangular, truncated triangle, letter-shaped (e.g., C, L, T, S, U, X, V, and W, among others) or other geometrical orientation. Quadrilateral shapes include rectangle, square, trapezoid, diamond and the like. At least two slag retainers 240 of the same group 305 have a different geometric orientation. Alternatively or in addition, one or more retainers 240 of the same group 305 have a common geometric orientation. In one example, each slag retainer 240 of a common group 305 is separated by a space or gap.

In the example depicted in FIG. 3, each group 305 of slag retainers 240 includes four slag retainers 240 arranged in a diamond orientation. For example, each of the slag retainers 240 includes a major surface 315 that is diagonally oriented, for example at an angle 320 of about 45 degrees from a vertical axis 325 or a horizontal axis 330. The vertical axis 325 is generally aligned in the same direction as the central vertical axis of the sidewall 125. Each slag retainer 240 within a common group 305 is spaced to form a gap 335 the neighboring slag retainer 240 the common group 305 of slag retainers 240. A dashed box 340 shown in FIG. 3 represents a square foot, and the macro-pattern 300 comprises approximately 24 slag retainers 240 per square foot, although the density of slag retainers 240 may be different or even vary within the pattern 300.

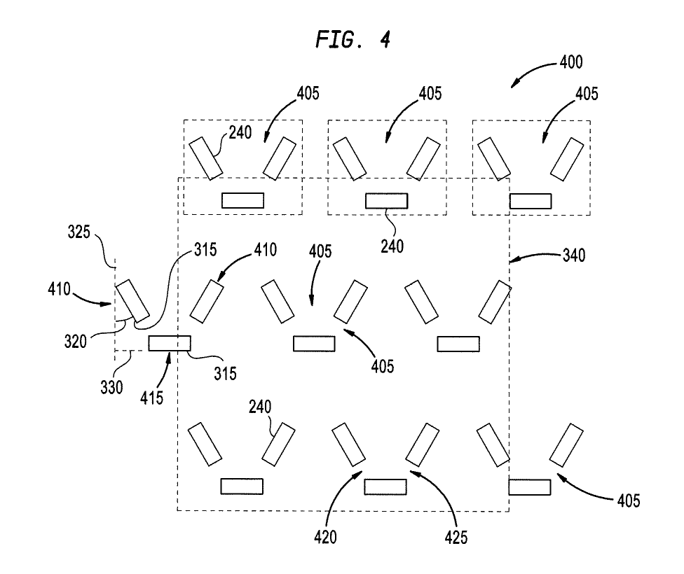

FIG. 4 shows a macro-pattern 400 comprising a plurality of groups 405 of slag retainers 240. Each group 405 of the slag retainers 240 comprising the macro-pattern 400 includes at least two slag retainers 240 that are fixed to the inner surface 210 of the hot plate 200 (as shown in FIG. 2). The groups 405 comprising the macro-pattern 400 may include slag retainers 240 having substantially the same geometric orientation of slag retainers 240 that repeat over the inner surface 210 of the hot plate 200. Alternatively, some or all the groups 405 comprising the macro-pattern 400 may include slag retainers 240 having different geometric orientations of slag retainers 240. In the example depicted in FIG. 4, each group 305 of slag retainers 240 includes at least three slag retainers 240 arranged in a cup or horse-shoe shape which is open to the top of the sidewall 125. For example, each group 405 of slag retainers 240 comprises two side plates 410 and a bottom plate 415. Each side plate 410 includes a major surface 315 that is diagonally oriented, for example at an angle 320 of about 45 degrees from a vertical axis 325. Each of the bottom plates 415 includes a major surface 315 that is coplanar with a horizontal axis 330. Each of the slag retainers 240 is spaced to form two gaps 420 between the bottom plate 415 and the side plates 410 within each group 405. A funnel shaped opening 425 is provided between the side plates 410 of each group 405. A dashed box 340 shown in FIG. 4 represents a square foot, and the macro-pattern 400 of slag retainers 240 comprises approximately 17 slag retainers 240 per square foot, although the density of slag retainers 240 may be different or even vary within the pattern 300.

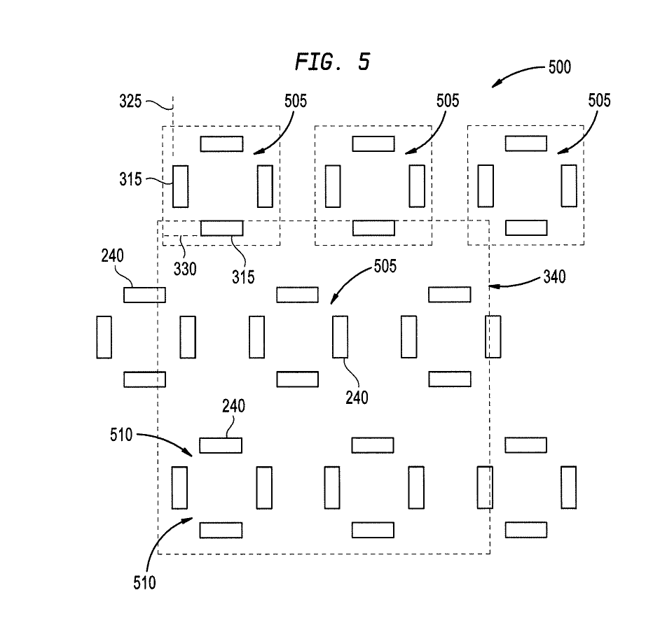

FIG. 5 shows a macro-pattern 500 of slag retainers 240 comprising a plurality of groups 505. Each group 505 of slag retainers 240 comprise a plurality of slag retainers 240 that are fixed to the inner surface 210 of the hot plate 200 (as shown in FIG. 2). The groups 505 comprising the macro-pattern 500 may include slag retainers 240 having substantially the same geometric orientation of slag retainers 240 that repeat over the inner surface 210 of the hot plate 200. Alternatively, some or all the groups 505 comprising the macro-pattern 500 may include slag retainers 240 having different geometric orientations of slag retainers 240.

Each of the groups 505 illustrated in FIG. 5 comprises four slag retainers 240 in a rectangular or box shape. For example, each of the slag retainers 240 include a major surface 315 that is oriented along (e.g., an angle of about 0 relative to) a vertical axis 325 and a horizontal axis 330. Each of the slag retainers 240 is spaced to form four gaps 510 within each group 505. A dashed box 340 shown in FIG. 5 represents a square foot, and the macro-pattern 500 of slag retainers 240 comprises approximately 20 slag retainers 240 per square foot, although the density of slag retainers 240 may be different or even vary within the pattern 300.

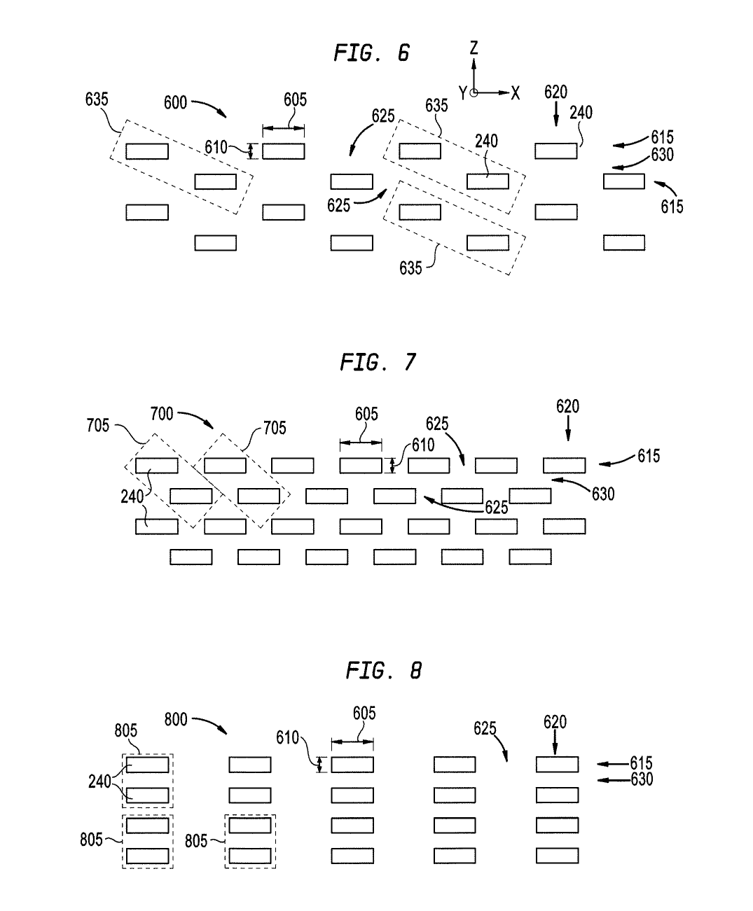

FIG. 6 shows another embodiment of a pattern 600 comprising a plurality of slag retainers 240 in elevation view. Each of the slag retainers 240 include a rectangular cross-section and a height (the height extending out of the page). In this example, each of the slag retainers 240 includes a length 605 (along the Y-X plane) and a width 610 (along the Y-Z plane), and the length 605 is greater than the width 610. In this embodiment, the pattern 600 comprises a pattern of rows 615 staggered with respect to a pattern of columns 620 consisting of the slag retainers 240 such that vertical gaps 625 and lateral gaps 630 are formed between the slag retainers 240 in the columns 620 and the rows 615, respectively. One or both of the pattern of rows 615 and the pattern of columns 620 may be linear or non-linear. In this embodiment, the lateral gaps 630 correspond with the width 610 and the vertical gaps 625 correspond with the length 605 of an adjacent slag retainer 240. The pattern of rows 615 and/or the pattern of columns 620 may be a micro-pattern within the pattern 600 (e.g., a macro-pattern). For example, one embodiment of a micro-pattern 635 includes two or more diagonally oriented slag retainers 240.

FIG. 7 shows another embodiment of a pattern 700 comprising a plurality of slag retainers 240 in elevation view. Each of the slag retainers 240 include a rectangular cross-section and a height (the height extending out of the page). In this example, each of the slag retainers 240 includes the length 605 (along the Y-X plane) and the width 610 (along the Y-Z plane), and the length 605 is greater than the width 610. In this embodiment, the pattern 700 comprises the pattern of rows 615 and a pattern of columns 620 consisting of the slag retainers 240 such that vertical gaps 625 and lateral gaps 630 are formed between the slag retainers 240 in the columns 620 and the rows 615, respectively. One or both of the pattern of rows 615 and the pattern of columns 620 may be linear or non-linear. In this embodiment, the lateral gaps 630 correspond with a fraction of the width 610 and the vertical gaps 625 correspond with the length 605 of an adjacent slag retainer 240. The pattern of rows 615 and/or the pattern of columns 620 may be a micro-pattern within the pattern 700 (e.g., a macro-pattern). In this example, one embodiment of a micro-pattern 705 includes two or more diagonally oriented slag retainers 240. The micro-pattern 705 differs from the micro-pattern 635 as the slag retainers 240 of the micro-pattern 705 at least partially overlap in the Z direction, whereas the slag retainers 240 of the micro-pattern 635 of FIG. 6 do not.

FIG. 8 shows another embodiment of a pattern 800 comprising a plurality of slag retainers 240 in elevation view. Each of the slag retainers 240 include a rectangular cross-section and a height (the height extending out of the page). In this example, each of the slag retainers 240 includes the length 605 (along the Y-X plane) and the width 610 (along the Y-Z plane), and the length 605 is greater than the width 610. In this embodiment, the pattern 800 comprises a pattern of rows 615 aligned with respect to a pattern of columns 620 consisting of the slag retainers 240 such that vertical gaps 625 and lateral gaps 630 are formed between the slag retainers 240 in the columns 620 and the rows 615, respectively. One or both of the pattern of rows 615 and the pattern of columns 620 may be linear or non-linear. In this embodiment, the lateral gaps 630 correspond with the width 610 and the vertical gaps 625 are aligned. The lateral gaps 630 also correspond with the length 605 of an adjacent slag retainer 240. One embodiment of a micro-pattern 805 in FIG. 8 includes two or more adjacent vertically oriented slag retainers 240. The micro-pattern 805 may repeat, as necessary, with thin the pattern 800 (e.g., a macro-pattern).

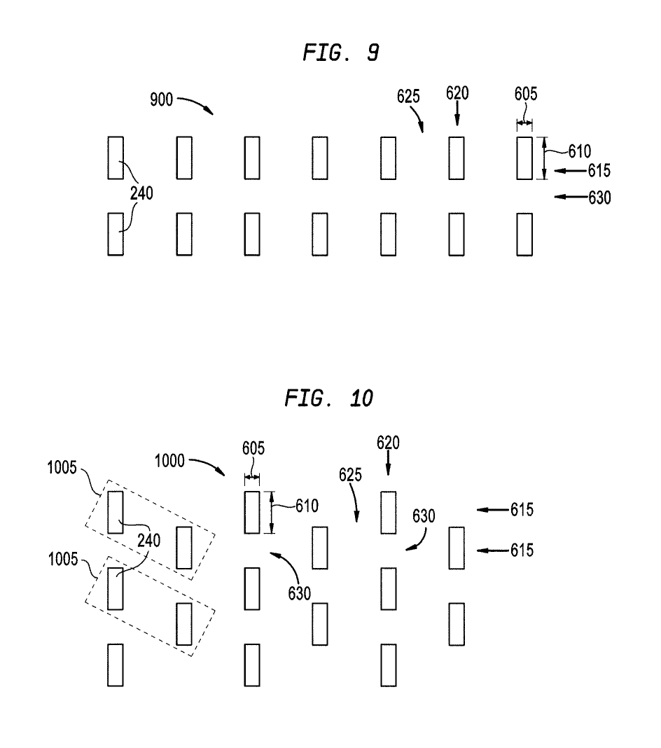

FIG. 9 shows another embodiment of a pattern 800 comprising a plurality of slag retainers 240 in elevation view. Each of the slag retainers 240 include a rectangular cross-section and a height (the height extending out of the page). In this example, each of the slag retainers 240 includes the length 605 (along the Y-X plane) and the width 610 (along the Y-Z plane), and the width 610 is greater than the length 605. In this embodiment, the pattern 800 comprises a pattern of rows 615 aligned with respect to a pattern of columns 620 consisting of the slag retainers 240 such that vertical gaps 625 and lateral gaps 630 are formed between the slag retainers 240 in the columns 620 and the rows 615, respectively. One or both of the pattern of rows 615 and the pattern of columns 620 may be linear or non-linear. In this embodiment, the lateral gaps 630 correspond with a fraction of the width 610 and the vertical gaps 625 correspond with the length 605. Additionally, the vertical gaps 625 are aligned. The lateral gaps 630 also correspond with the length 605 of an adjacent slag retainer 240.

FIG. 10 shows another embodiment of a pattern 1000 comprising a plurality of slag retainers 240 in elevation view. Each of the slag retainers 240 include a rectangular cross-section and a height (the height extending out of the page). In this example, each of the slag retainers 240 includes the length 605 (along the Y-X plane) and the width 610 (along the Y-Z plane), and the width 610 is greater than the length 605. In this embodiment, the pattern 800 comprises a pattern of rows 615 that are staggered with respect to a pattern of columns 620 consisting of the slag retainers 240 such that vertical gaps 625 and lateral gaps 630 are formed between the slag retainers 240 in the columns 620 and the rows 615, respectively. One or both of the pattern of rows 615 and the pattern of columns 620 may be linear or non-linear. In this embodiment, the lateral gaps 630 correspond with the width 610 and the vertical gaps 625 correspond with a fraction of the length 605. Additionally, the vertical gaps 625 are aligned while the lateral gaps 630 are staggered. One embodiment of a micro-pattern 1005 includes two or more diagonally oriented slag retainers 240.

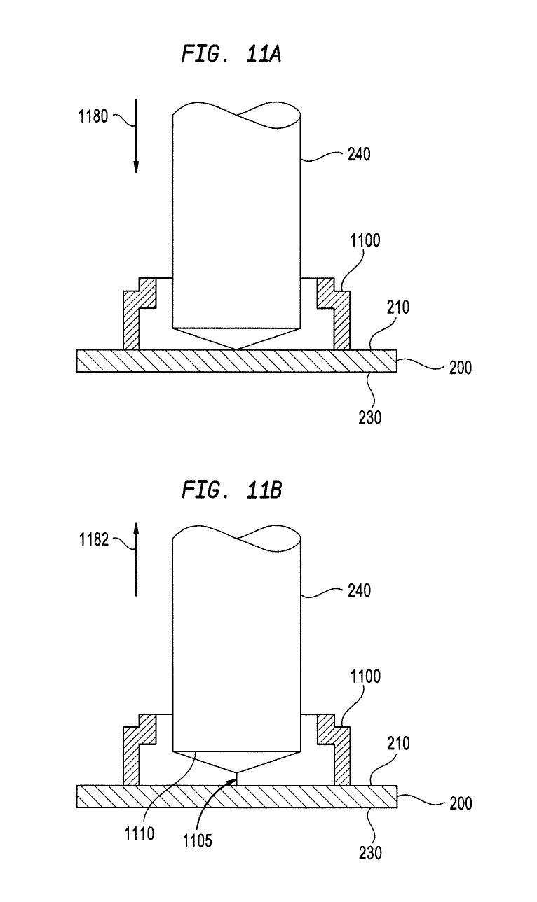

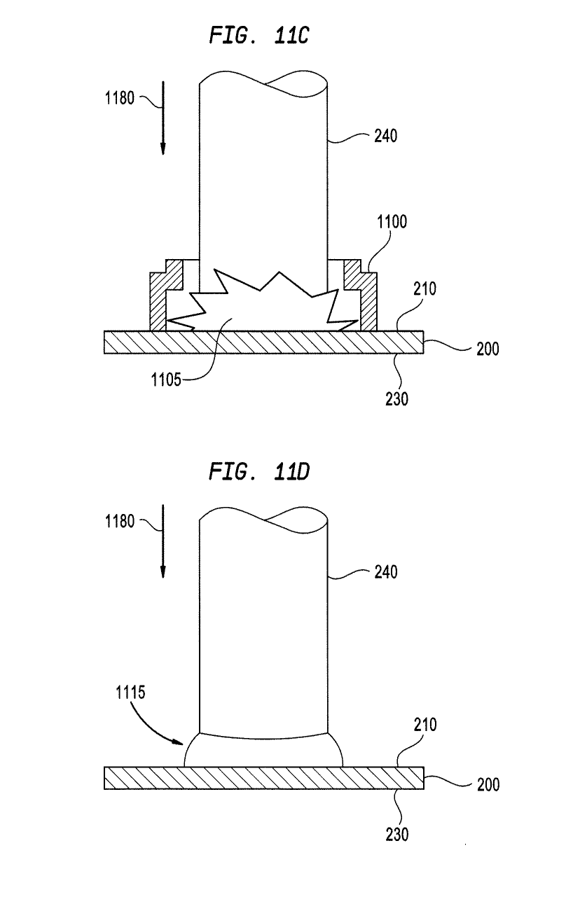

FIGS. 11A-11D are schematic partial cross-sectional views depicting a method for fixing the slag retainers 240 to the inner surface 210 of the hot plate 200 to form the micro-patterns and the macro-patterns described above, among other patterns. The method described in FIGS. 11A-11D is a capacitive discharge (CD) welding process but other joining processes may be utilized to fix the slag retainers 240 to the hot plate 200. Examples include brazing or arc welding processes, such as shielded metal arc welding (SMAW), flux-core arc welding (FCAW), gas metal arc welding (GMAW), gas tungsten arc welding (GTAW), among other welding processes.

In particular, the CD welding process is particularly efficient at welding the slag retainers 240 having high aspect ratios to the hot plate 200. Thus, the method described over the sequence illustrated in FIGS. 11A-D is particularly useful in fabricating new sidewalls, and rebuilding and refurbishing hotplates for reuse in sidewalls.

In FIG. 11A, the slag retainer 240 is shown positioned on the inner surface 210 of the hot plate 200. A ceramic ferrule 1100 surrounds the slag retainer 240 and contacts the inner surface 210 of the hot plate 200. The slag retainer 240 may be supported by a stud welding gun (not shown) that urges the slag retainer 240 against the inner surface 210 of the hot plate 200 in a direction shown by arrow 1180 illustrated in FIG. 11A.

FIG. 11B, the stud welding gun is triggered. The stud welding gun has a lift mechanism that lifts the slag retainer 240 slightly away from the inner surface 210 of the hot plate 200 in a direction shown by arrow 1182 illustrated in FIG. 11B when triggered. Additionally, the stud welding gun produces an electric arc 1105 between a tip of the slag retainer 240 and the inner surface 210 of the hot plate 200. The electric arc melts a base area 1110 of the slag retainer 240 and a portion of the inner surface 210 of the hot plate 200. The base area 1110 of the slag retainer 240 may be pointed or include a nub to enhance formation of the arc 1105.

FIG. 11C illustrates the arc 1105 which joins the slag retainer 240 to the inner surface 210 of the hot plate 200. A timer may stop the electrical current that produces the arc 1105. The ceramic ferrule 1100 concentrates the heat produced by the arc 1105. The ceramic ferrule 1100 also functions to contain the molten material in the weld area. The lift mechanism of the stud welding gun is also de-energized which causes the slag retainer 240 to plunge into the molten material in the direction of the arrow 1180 illustrated in FIG. 11C.

FIG. 11D shows the slag retainer 240 joined to the inner surface 210 of the hot plate 200 by a weld 1115. The weld 1115 is produced by the solidification of the molten material produced by the arc 1105 once the current to the slag retainer 240 is terminated. The ceramic ferrule 1100 is also removed from the slag retainer 240 in FIG. 11D.

The process illustrated in FIGS. 11A-D is be repeated to recreate groups of slag retainers arranged in micro-patterns that are part of a larger macro-pattern of slag retainers CD welded to the hot plate. The process illustrated in FIGS. 11A-D may also be utilized to replace one or more slag retainers in an existing macro-pattern, or to add additional slag retainers to existing groups or to create new groups of slag retainers in an existing macro-pattern.

The micro-patterns comprising the slag retainers 240 that form the macro slag retainer patterns as described above are less costly to manufacture as opposed to conventional slag retainer designs. The conventional slag retainers are typically complicated shapes that may not be compatible to CD welding processes. This makes the conventional slag retainers much more costly and time consuming to install. For example, one conventional slag retainer pattern includes a four-sided slag retainer structure that resembles a U shape or horseshoe shape in cross-section. In this particular pattern, there are approximately 10 slag retainer structures per square foot of hot plate (e.g., thousands of slag retainer structures per roof or sidewall). According to embodiments described herein, there are more slag retainers 240 per square foot to complete a good slag retainer coverage scheme, the slag retainers 240 can be installed at a rate of about 20 slag retainer studs per minute as compare to welding one conventional slag retainer structure, which takes several minutes.

While the foregoing is directed to embodiments of the present disclosure, other and further embodiments may be devised without departing from the basic scope thereof, and the scope thereof is determined by the claims that follow.

What is claimed is:

1. A furnace sidewall comprising:
a hot plate having an inner surface facing configured to face an interior volume of a metallurgical furnace and a bottom surface configured to face a hearth of the metallurgical furnace; and
a plurality of slag retainers extending inwardly from the inner surface of the hot plate, the plurality of slag retainers arranged in a macro-pattern of slag retainer groups, the slag retainer groups comprising at least two or more of the slag retainers arranged in a micro-pattern.

2. The sidewall of claim 1, wherein each slag retainer comprising the micro-pattern includes a major surface that is diagonal to both a vertical axis and a horizontal axis of the hot plate.

3. The sidewall of claim 2, wherein the major surfaces are angled at about 45 degrees from the vertical axis.

4. The sidewall of claim 1, wherein slag retainers of the micro-pattern are arranged in a wave, spiral, curve, linear, off-set, polygonal, quadrilateral, triangular, truncated triangle, or letter-shaped geometrical orientation.

5. The sidewall of claim 1, wherein the micro-pattern comprises at least three slag retainers.

6. The sidewall of claim 5, wherein a gap is provided between each of the slag retainers comprising the micro-pattern.

7. The sidewall of claim 1, wherein gaps defined between the slag retainers comprising the micro-pattern are smaller than a distance between adjacent groups of slag retainers.

8. The sidewall of claim 1, wherein the micro-pattern of at least two adjacent slag retainer groups have substantially the same geometric orientation.

9. The sidewall of claim 1 further comprising:
a cover plate coupled to the hot plate in a spaced-apart relation; and
a plurality of spray nozzles disposed in a volume defined between the cover plate and hot plate, the spray nozzles oriented to spray liquid on the hot plate.

10. A furnace sidewall comprising:
a ring-shaped steel hot plate having an inner surface facing inward; and
a plurality of slag retainers welded to the inner surface of the hot plate, the slag retainers projecting inward from the inner surface, the plurality of slag retainers are arranged in a pattern of discrete slag retainer groups, the retainer groups having a substantially similar micro-pattern comprised of at least two spaced apart slag retainers of the plurality of slag retainers, the two spaced apart slag retainers having different geometric orientations.

11. The sidewall of claim 10, wherein slag retainers comprising the micro-pattern are arranged in a wave, spiral, curve, linear, off-set, polygonal, quadrilateral, triangular, truncated triangle, or letter-shaped geometrical orientation.

12. The sidewall of claim 10 further comprising:
another group of slag retainers having a micro-pattern different than the micro-pattern of slag retainers comprising the pattern of discrete slag retainer groups.

13. The sidewall of claim 10, where each of the slag retainers comprising the micro-pattern is capacitively discharge welded to the hot plate.

14. A metallurgical furnace, comprising:
a hearth; and
a sidewall disposed on the hearth and surrounding an interior volume of the metallurgical furnace, the sidewall comprising:
a hot plate having an inner surface facing the interior volume;
a cover plate surrounding the hot plate in a spaced-apart relation;
a plurality of spray nozzles disposed in a volume defined between the cover plate and hot plate, the spray nozzles oriented to spray a liquid on the hot plate; and
a plurality of slag retainers welded to the inner surface of the hot plate, the slag retainers projecting inward from the inner surface, the plurality of slag retainers are arranged in a pattern of discrete slag retainer groups, at least two of the retainer groups having a substantially similar micro-pattern comprised of at least two spaced apart slag retainers of the plurality of slag retainers, the two spaced apart slag retainers having different geometric orientations.

15. The furnace of claim 14, wherein slag retainers comprising the micro-pattern are arranged in a wave, spiral, curve, linear, off-set, polygonal, quadrilateral, triangular, truncated triangle, or letter-shaped geometrical orientation.

16. The furnace of claim 14, where each of the slag retainers comprising the substantially similar micro-patterned groups is capacitively discharge welded to the hot plate.

17. The sidewall of claim 16, wherein a gap is provided between each of the slag retainers comprising the micro-pattern.

18. The furnace of claim 17, wherein gaps defined between the slag retainers comprising the micro-pattern are smaller than a distance between adjacent groups of slag retainers.

19. The furnace of claim 14, wherein the micro-pattern of at least two adjacent slag retainer groups have substantially the same geometric orientation.

20. The furnace of claim 14, wherein at least two groups of slag retainers have different micro-patterns.
